(19) United States
(12) Patent Application Publication
(10) Pub. No.: US 2012/0303144 A1
(43) Pub. Date: Nov. 29, 2012

(54) METHOD AND DEVICE FOR THE UNIFORM NAMING OF IDENTICAL PARAMETERS OF DIFFERENT FIELD DEVICES OF AN AUTOMATION SYSTEM

(75) Inventors: Daniel GROSSMANN, Schriesheim (DE); Alexander KAISER, Heddesheim (DE); Benjamin DANZER, Mannheim (DE); Dirk JOHN, Karlsruhe (DE); Dirk SCHULZ, Meckenheim (DE); Roland BRAUN, Niederkassel Lulsdorf (DE); Stefan BOLLMEYER, Minden (DE)

(73) Assignee: ABB Technology AG, Zurich (CH)

(21) Appl. No.: 13/469,781

(22) Filed: May 11, 2012

(30) Foreign Application Priority Data
May 11, 2011 (DE) 102011101154.8

(51) Int. Cl. G06F 17/00

(52) U.S. Cl. 700/90

(57) ABSTRACT

Exemplary embodiments are directed to a method and device for unifying differing designations of physically identical parameters of different field devices of the same type in an automation system. The field devices being parameterized from at least one central control unit via a communication network. A control unit, in each of the different field devices of the same type, identifies the physically identical parameters by semantic analysis of the differing designations, after which, in each case, an identical identification is attached to the differing designations.

### RELATED APPLICATION

This application claims priority under 35 U.S.C. §119 to German Patent Application No. 102011101154.8 filed in Germany on May 11, 2011, the entire content of which is hereby incorporated by reference.

### FIELD

The disclosure relates to a field device, such as a method and device for unifying differing designations of physically identical parameters of different field devices of the same type in an automation system, which are parameterized from at least one central processing unit via an industrial communication protocol such as HART, Profibus, Profinet or the like.

### SUMMARY

An exemplary method for the unification of differing designations of physically identical parameters of different field devices of the same type in an automation system, which are parameterized via a communication network from at least one central control unit, is disclosed. The method comprising: identifying, by means of the control unit in the different field devices of the same type, the physically identical parameters thought a semantic analysis of the differing designations; and attaching an identical identification to the differing designations of identical parameters are identified.

An exemplary device for unifying of differing designations of physically identical parameters of different field devices of the same type in an automation system, which can be parameterized via a communication network, is disclosed. The device comprising: a control unit that identifies in the different field devices of the same type, the physically identical parameters by semantic analysis of the differing designations and attaches, in each case, an identical identification to the differing designations.

An exemplary computer readable medium storing a computer program product for a method of unifying different designations of physically identical parameters of different field devices of the same type in an automatic system is disclosed, which, when in communicable contact with a device, causes the device to execute the steps of: identifying, by means of the control unit in the different field devices of the same type, the physically identical parameters thought a semantic analysis of the differing designations; and attaching an identical identification to the differing designations of identical parameters are identified.

### BACKGROUND INFORMATION

Field devices have become more and more complex and intelligent in their structure and range of functions, respectively. This finds expression in a high number of parameters of the field devices. These parameters occur in a large variety and are different with regard to their designation depending on manufacturer, although differing designations can be allocated to physically identical parameters of field devices from different manufacturers.

This situation increasingly results in problems for the user such that the quantity and non-uniform designation of such parameters increases with the size and complexity of the automation system and becomes confusing. An integration of field devices into an automation system is, therefore, quite time consuming. In particular, the meanings of designations of the parameters must be found out via corresponding documentation of the manufacturer before there can be any linkage into the automation system.

DE 10 2007 026 678 A1 discloses a basic configuration of an automation system, which includes a number of field devices connected to an electronic control unit via a digital field bus, for example, PROFIBUS. For a field device to be replaced with a new field device, previous parameters, information and/or values of the field device to be replaced are compared by an electronic control unit, communicating via the field bus, with parameters, information or values of the new field device with respect to at least one data record in order to change the latter, if necessary, in accordance with the field device to be replaced.

If the new field device comes from another manufacturer than the field device to be replaced, the aforementioned problems occur of an in most cases non-uniform designation of the parameters which are actually physically identical, which must be interpreted by the user in a time-consuming manner in order to perform the system integration.

### BRIEF DESCRIPTION OF THE DRAWINGS

In the text which follows, further measures improving the disclosure are shown in greater detail together with the description of exemplary embodiments of the disclosure, by means of the figures, in which:

FIG. 1 shows a schematic block diagram representation of an automation system that includes field devices in accordance with an exemplary embodiment, and

FIG. 2 shows a schematic representation of a unification of differing designations in accordance with an exemplary embodiment.

### DETAILED DESCRIPTION

Exemplary embodiments of the present disclosure are directed to automation systems in the context of industrial plants, for example process engineering. To control the procedural sequences, field devices having valves as actuators and sensors for detecting physical quantities and the like are used to communicate with a higher-level controller and with one another via the industrial communication protocol. Such field devices have integrated electronic units for linkage to a bus and for local data processing. In the case of known automation systems, which use a communication protocol for communication, higher levels of field device information are integrated in order to modernize work processes, improve process and product quality and maximize the availability.

Configuration functions, parameterization functions, and diagnostic functions of an exemplary control system of the present disclosure thus also relate to the field devices. In the context of the present disclosure, the term field device is used for intelligent sensors, actuators, analysis devices, and low-voltage devices which can be integrated into an automation system via a bus connection. By using intelligent field devices and with the utilization of modern communication protocols, a multiplicity of functions can be implemented in the automation system, such as operating functions, commissioning functions, diagnostic functions, maintenance functions, optimization functions, alarm processing functions and the like.

Exemplary embodiments of the present disclosure create a method and a device by means of which reliable and time-saving integration of a field device can be carried out in spite of a non-uniform designation of the parameters.

The exemplary embodiments disclosed herein provide a process-related teaching that by means of a preferably central control unit, for example, in the different field devices of the same type, the physically identical parameters are identified by semantic analysis of the differing designations after which and in each case identical identification is attached to the different designations.

With the aid of this additional identification, the differing designations are unified in a simple manner so that even an automatic recognition of different field devices of the same type can be carried out. This eliminates the error of misinterpretations of the parameters.

If the field device is, for example, a temperature sensor, there are different possibilities of influencing how the temperature value is supplied. These possibilities can be adjusted at the field device by parameterization. Thus, the parameter can be supplied in degrees Celsius (° C.), Kelvin (K) or degrees Fahrenheit (F.). A corresponding allocation of the desired measurement-value unit can be carried out at a parameter mask. However, the measurement-value unit is designated differently depending on manufacturer and can be called, for example, “TempUnit” or “PVUnit” or “TUnit” or the like, since the designation is not standardized industrially. Since the meaning of these abbreviated designations does not unambiguously show that the measurement-value unit is meant by this, the parameterization process specifies the complexity explained above and is susceptible to errors with regard to interpretations.

The attaching of the respective identification identical to these abbreviated designations and thus unified can be carried out there by filling out a property field of the parameter designed, as a rule, as a software object. Thus, for example, the identification “processvalue.unit” is attached to the abbreviated designation “TempUnit” as a property of the object. By this means, the measurement-value units of the temperature sensors can be found unambiguously and rapidly and the parameter can be allocated corresponding to the specifications of the automation system, for example set to degrees Celsius (° C.). The search for the identification can then be carried out in an automated manner.

A part from the measurement-value unit, measuring-range limits, alarm boundaries and the like can also be treated in the same manner in the exemplary example of a temperature sensor. The solution according to the present disclosure can be used for linkage into an existing automation system during the initial commissioning of a field device. However, it is also possible to use this solution during the operation in order to determine the status of a field device, for which purpose, for example, the “device.status” identification can be used. The solution according to the present disclosure thus supports the planning of an automation system as well as commissioning, operation and maintenance.

For the automatic unification of the designations in accordance with exemplary embodiments of the present disclosure, the device descriptions of all field devices of the automation system can be imported, which are electronically present as a file, in a central device catalog. Next, the respective meanings of the designations are found via an analysis of the various designations of the parameters and of the transmission protocol, and entered in the form of a unified identification as a property of the object.

If the analysis of the device description supplies incomplete information, a communication link can be set up with the field device and the data still missing are determined directly from the field device via means of the industrial communication protocol, so that the meaning of the parameters can be determined.

In another exemplary embodiment of the present disclosure, the field device can be designed, apart from the temperature sensor specified above in an exemplary manner, as a pressure sensor, position sensor, flow sensor, voltage and current meter or other field device as desired in an automation system and its specific functionally determined parameters are processed analogously by the exemplary method disclosed herein.

For the recognition and processing of the designation of the parameters, these should represent a character string containing at least one letter and/or number. This is because such character strings can be found and processed advantageously in automated manner. This does not exclude the possibility that the designations can also be pictorial—particularly of symbolic nature—if an unambiguous recognition, allocation and processing is possible.

Analogously, the added identification should be designed as a character string also comprising (e.g., consisting at least of) letters and/or numbers, at least when the designation of the parameter is also present in this form. This makes it possible to link the identification with the designation in the same format.

Exemplary embodiments of the present disclosure can be implemented advantageously by a computer program product, especially for automation purposes, wherein the routine for the unification of the differing designations of physically identical parameters of different field devices of the same type is implemented by corresponding control commands stored in a piece of software.

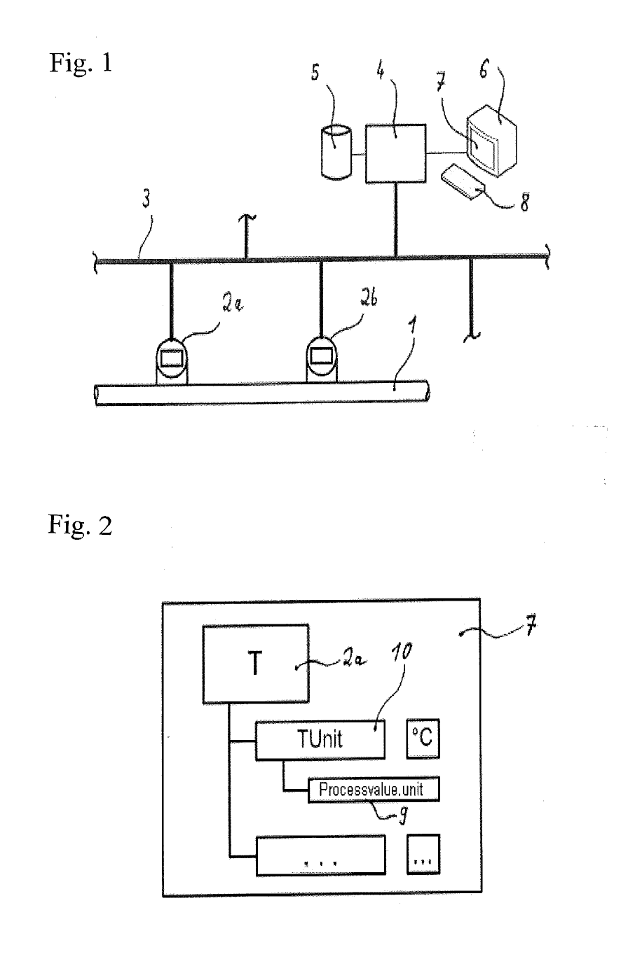

FIG. 1 shows a schematic block diagram representation of an automation system that includes field devices in accordance with an exemplary embodiment. As shown in FIG. 1, an automation system of a process-engineering plant includes a number of field devices 2a and 2b, arranged in an exemplary pipeline 1, which in this case represent by way of example temperature measuring devices which are connected to a communication network 3 via an integrated bus interface in order to forward the determined temperature measurement data via the communication network 3 to a central control unit 4 in accordance with the bus protocol.

Furthermore, the field devices 2a and 2b also includes other functions such as self-testing functions, life-counting function and the like which can also be monitored via the communication network 3. The field devices 2a and 2b can be parameterized from the central control unit 4 in that a corresponding input is carried out by the user via an associated keyboard 8 via a connected monitor 6 by parameterization mask 7. A data base 5 allocated to the central control unit 4 contains a device catalog having data records of stored device descriptions of each field device 2a and 2b connected, and for this purpose, the same identifications are attached to differing designations as determined by the method explained in the text which follows.

FIG. 2 shows a schematic representation of a unification of differing designations in accordance with an exemplary embodiment. As shown in FIG. 2, the field device 2a, which is a temperature sensor, is shown in a parameterization mask. The parameters which can be changed for the field device 2a include, among other things, the measurement-value unit which has been given the designation “TUnit” by the manufacturer and is set with the preselection degrees Celsius (° C.). The interpretation of the abbreviated designation “TUnit” is carried out by the control unit 4, not shown in greater detail, by semantic analysis, using a device catalog. Next, the uniform identification “processvalue.unit” is attached to this manufacturer-specific designation “TUnit” by filling out a property field 9 for the parameter designed as a software object 10.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE DESIGNATIONS

1 Pipeline
2 Field device
3 Communication network
4 Control unit
5 Database
6 Monitor
7 Parameterization mask
8 Keyboard
9 Property field
10 Software object

1. A method for unifying differing designations of physically identical parameters of different field devices of the same type in an automation system, which are parameterized via a communication network from at least one central control unit, comprising:
identifying, by means of the control unit in the different field devices of the same type, the physically identical parameters thought a semantic analysis of the differing designations; and
attaching an identical identification to the differing designations of identical parameters are identified.

2. The method as claimed in claim 1, wherein attaching the identical identification is carried out by filling out a property field of the parameter designed as a software object.

3. The method as claimed in claim 1, wherein unifying the differing designations is carried out during an initial parameterization in a commissioning of a field device in the automation system.

4. The method as claimed in claim 1, wherein unifying the differing designations is carried out during the operation of the automation system during a reprogramming of field devices in the automation system.

5. A device for unifying of differing designations of physically identical parameters of different field devices of the same type in an automation system, which can be parameterized via a communication network, comprising:
a control unit that identifies in the different field devices of the same type, the physically identical parameters by semantic analysis of the differing designations and attaches, in each case, an identical identification to the differing designations.

6. The device as claimed in claim 5, wherein the control unit selects the field device of the same type from a group comprising: temperature, pressure and position sensor, flow meter, voltage, force and current meter and analysis devices and controllers.

7. The device as claimed in claim 5, wherein the control unit selects the parameter from a group comprising: temperature, pressure, position or travel value, voltage, current, flow, force, quantity.

8. The device as claimed in claim 5, wherein the designation of the parameter is a character string containing at least letters and/or numbers.

9. The device as claimed in claim 5, wherein the added identification is a character string containing at least letters and/or numbers.

10. A computer readable medium storing a computer program product for a method of unifying different designations of physically identical parameters of different field devices of the same type in an automatic system, which, when in communicable contact with a device, causes the device to execute the steps of:
identifying, by means of the control unit in the different field devices of the same type, the physically identical parameters thought a semantic analysis of the differing designations; and
attaching an identical identification to the differing designations of identical parameters are identified.

11. The computer readable medium of claim 10, wherein attaching the identical identification is carried out by filling out a property field of the parameter designed as a software object.

12. The computer readable medium of claim 10, wherein unifying of the differing designations is carried out during an initial parameterization in a commissioning of a field device in the automation system.

13. The computer readable medium of claim 10, wherein unifying the differing designations is carried out during the operation of the automation system during a reprogramming of field devices in the automation system.

14. The computer readable medium of claim 10, being in communicable contact with a control unit of the device.

15. The computer readable medium of claim 10, wherein the field device of the same type from a group comprising: temperature, pressure and position sensor, flow meter, voltage, force and current meter and analysis devices and controllers.

16. The computer readable medium of claim 10, wherein the control unit selects the parameter from a group comprising: temperature, pressure, position or travel value, voltage, current, flow, force, quantity.

17. The computer readable medium of claim 10, wherein the designation of the parameter is a character string containing at least letters and/or numbers.

18. The computer readable medium of claim 10, wherein the added identification is a character string containing at least letters and/or numbers.
